(19) United States
(12) Patent Application Publication
(10) Pub. No.: US 2024/0332932 A1
(43) Pub. Date: Oct. 3, 2024

(54) Multi-Gang Mounting Bracket for Electrical or Communication Device

(71) Applicant: Eaton Intelligent Power Limited, Dublin (IE)

(72) Inventors: Martin L. Witherbee, Godfrey, IL (US); Shane A. Semple, Canonsburg, PA (US)

(21) Appl. No.: 18/618,884

(22) Filed: Mar. 27, 2024

Related U.S. Application Data
(60) Provisional application No. 63/493,055, filed on Mar. 30, 2023.

(51) Int. Cl. H02G 3/10; F16M 13/02

(52) U.S. Cl. CPC H02G 3/10; F16M 13/02

(57) ABSTRACT

A mounting bracket attaches a junction box to a wall stud. The mounting bracket includes a face plate, stud mounting flange, and box mounting flange. The face plate has opposite upper and lower and opposite left and right edge margins. The stud mounting flange extends laterally from the left edge margin of the face plate. The box mounting flange is attached to the right edge margin of the face plate. A method of coupling a mounting bracket and junction box includes engaging a side wall of the junction box with a box mounting flange of the mounting bracket. A front surface of a face plate of the mounting bracket is flush with a front surface of the junction box. A stud mounting flange of the mounting bracket extends laterally from the side wall of the junction box and connects to a side end margin of the face plate.

### CROSS-REFERENCE TO RELATED APPLICATIONS

This application claims the benefit of U.S. Provisional Patent Application Ser. No. 63/493,055, filed on Mar. 30, 2023, the entire content of which is hereby incorporated by reference.

### FIELD OF THE DISCLOSURE

The present disclosure generally relates to a multi-gang junction box mounting bracket for mounting an electrical or communication device on a wall stud.

### BRIEF SUMMARY

In one aspect, the present disclosure provides a mounting bracket for attaching a junction box to a wall stud. The mounting bracket has a face plate, a stud mounting flange, and a box mounting flange. The face plate has opposite upper and lower edge margins and opposite left and right edge margins. The stud mounting flange extends laterally from the left edge margin of the face plate and attaches the mounting bracket to the wall stud. The box mounting flange is attached to the right edge margin of the face plate and engages a side wall of the junction box to couple the junction box to the mounting bracket.

In another aspect, the present disclosure provides a method of coupling a mounting bracket to a junction box. The method includes engaging a side wall of the junction box with a box mounting flange of the mounting bracket such that i) a front surface of a face plate of the mounting bracket is flush with a front surface of the junction box, and ii) a stud mounting flange of the mounting bracket extends laterally from the side wall of the junction box. The stud mounting flange is connected to a side end margin of the face plate and attaches the mounting bracket to a wall stud.

Other aspects will be in part apparent and in part pointed out hereinafter.

### BACKGROUND OF THE DISCLOSURE

Typically, an electrical or communication device is installed in a building using a mounting bracket. The communication device is fastened to the mounting bracket, and in turn, the mounting bracket is fastened to framing (e.g., a wall stud). In some circumstances, junction boxes are used to house and protect electrical and communication devices, such as electrical outlets, electrical switches, associated electrical wiring, communication terminals (e.g., terminals for fiber optics), and associated communication cables (e.g., optical fiber cables). The junction box is secured to the mounting bracket, so that, in turn, the electrical or communication device is secured to the mounting bracket.

### BRIEF DESCRIPTION OF THE DRAWINGS

FIG. 1 is a perspective of one embodiment of a stud-to-stud mounting bracket assembly attached to two wall studs spaced a standard distance apart, with a multi-gang junction box and a box cover plate mounted on the mounting bracket assembly;

FIG. 2 is the perspective of FIG. 1 with the box cover plate removed;

FIG. 3 is a perspective of a junction box of the assembly in FIG. 1;

FIG. 4 is a side view of the junction box in FIG. 3;

FIG. 5 is a perspective of a mounting bracket of the assembly in FIG. 1;

FIG. 6 is a front view of the mounting bracket in FIG. 1;

FIG. 7 is a left side view of the mounting bracket in FIG. 1;

FIG. 8 is a rear view of the mounting bracket in FIG. 1;

FIG. 9 is a top view of the mounting bracket in FIG. 1;

FIG. 10 is an enlarged fragmentary view of the mounting bracket in FIG. 1;

FIG. 11 is an enlarged fragmentary view of the mounting bracket in FIG. 1;

FIG. 12 is an enlarged fragmentary perspective of the assembly in FIG. 2;

FIG. 13 is a fragmentary cross-section through line 13-13 in FIG. 12;

FIG. 14 is a perspective of another embodiment of a stud-to-stud mounting bracket assembly attached to a wall stud, with a multi-gang junction box mounted on the mounting bracket assembly;

FIG. 15 is a perspective of another embodiment of a stud-to-stud mounting bracket assembly attached to two wall studs, with a junction box mounted on the mounting bracket assembly;

FIG. 16 is a perspective of another embodiment of a stud-to-stud mounting bracket assembly attached to a wall stud, with a junction box mounted on the mounting bracket assembly;

FIG. 17 is a perspective of a mounting bracket of another embodiment;

FIG. 18 is a perspective of a mounting bracket of another embodiment;

FIG. 19 is a rear view of the mounting bracket in FIG. 18;

FIG. 20 is a perspective of a mounting bracket of another embodiment;

FIG. 21 is a perspective of another embodiment of a stud-to-stud mounting bracket assembly attached to two wall studs, with a multi-gang junction box mounted on the mounting bracket assembly;

FIG. 22 is a perspective of a mounting bracket of the assembly in FIG. 21;

FIG. 23 is an enlarged fragmentary view of the perspective of FIG. 22;

FIG. 24 is a front view of the mounting bracket in FIG. 22;

FIG. 25 is an enlarged fragmentary view of FIG. 21;

FIG. 26 is an enlarged fragmentary front view of the assembly in FIG. 21;

FIG. 27 is a cross-section taken through line 27-27 in FIG. 26;

FIG. 28 is a perspective of another embodiment of a mounting bracket assembly attached to a wall stud, with a multi-gang junction box mounted on the mounting bracket assembly;

FIG. 29 is a respective of the multi-gang junction box in FIG. 28;

FIG. 30 is a side view of the multi-gang junction box in FIG. 29;

FIG. 31 is an enlarged fragmentary front view of the mounting bracket assembly in FIG. 28;

FIG. 32 is a perspective of a mounting bracket of the assembly in FIG. 28;

FIG. 33 is a front view of the mounting bracket in FIG. 32;

FIG. 34 is an enlarged fragmentary view of the mounting bracket in FIG. 33;

FIG. 35 is a perspective view of a mounting bracket of another embodiment;

FIG. 36 is a perspective view of a mounting bracket of another embodiment;

FIG. 37 is a perspective of another embodiment of a stud-to-stud mounting bracket assembly attached to a wall stud, with a multi-gang junction box mounted on the mounting bracket assembly;

FIG. 38 is a perspective of the mounting bracket assembly in FIG. 37;

FIG. 39 is a perspective of a mounting bracket of the assembly in FIG. 38;

FIG. 40 is a perspective of mounting bracket of another embodiment; and

FIG. 41 is a perspective of a stud-to-stud mounting bracket assembly including the mounting bracket in FIG. 40 attached to two wall studs, with a multi-gang junction box mounted on the mounting bracket assembly.

Corresponding reference characters indicate corresponding parts throughout the drawings.

### DETAILED DESCRIPTION

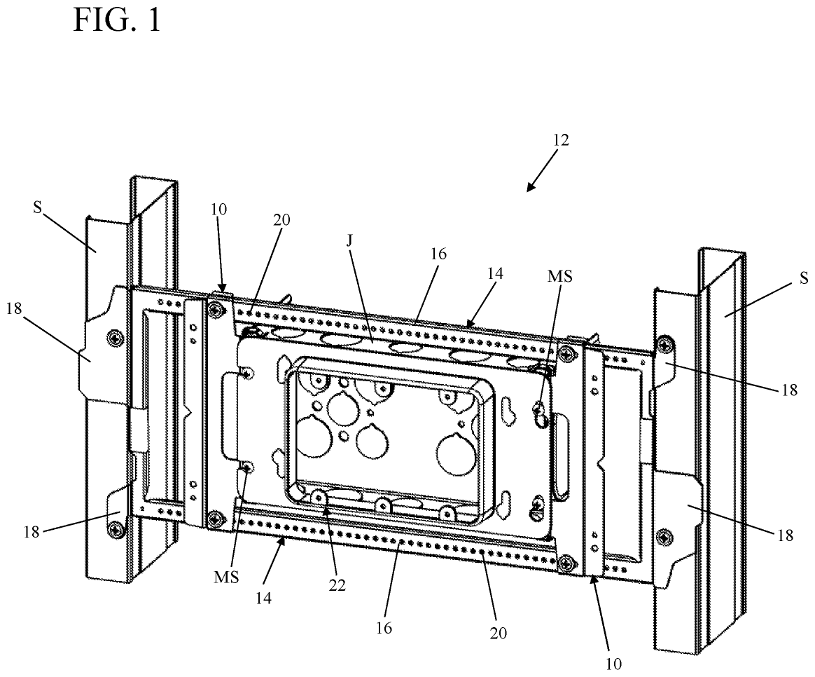

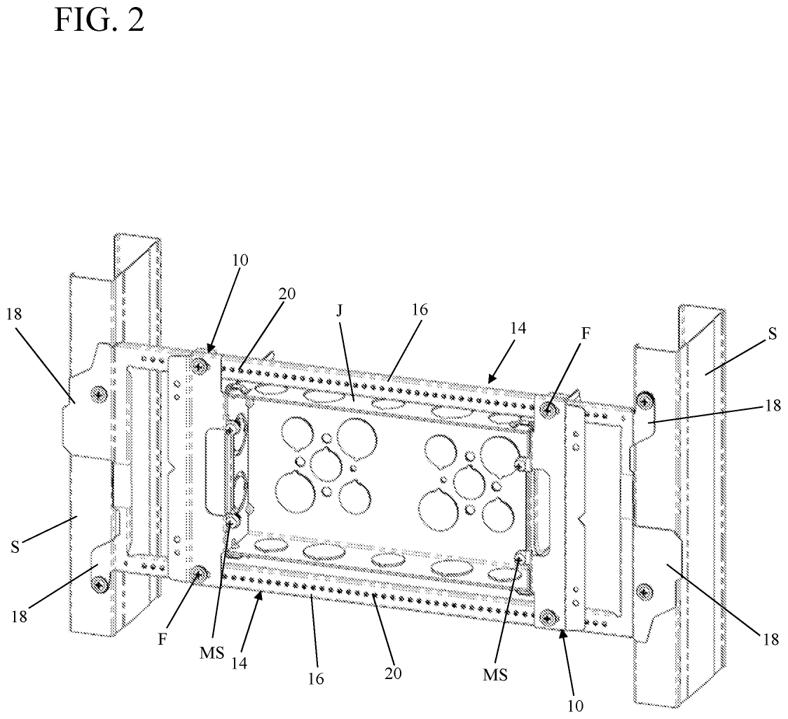

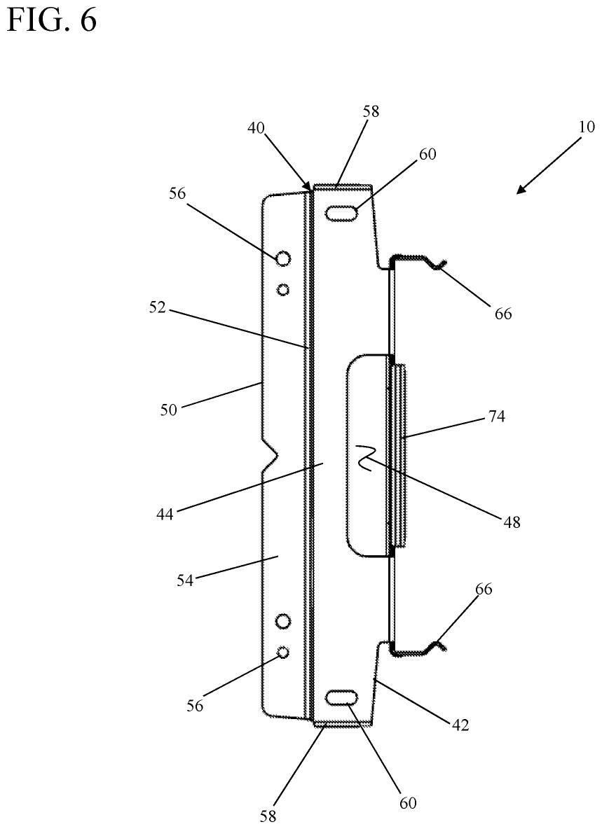

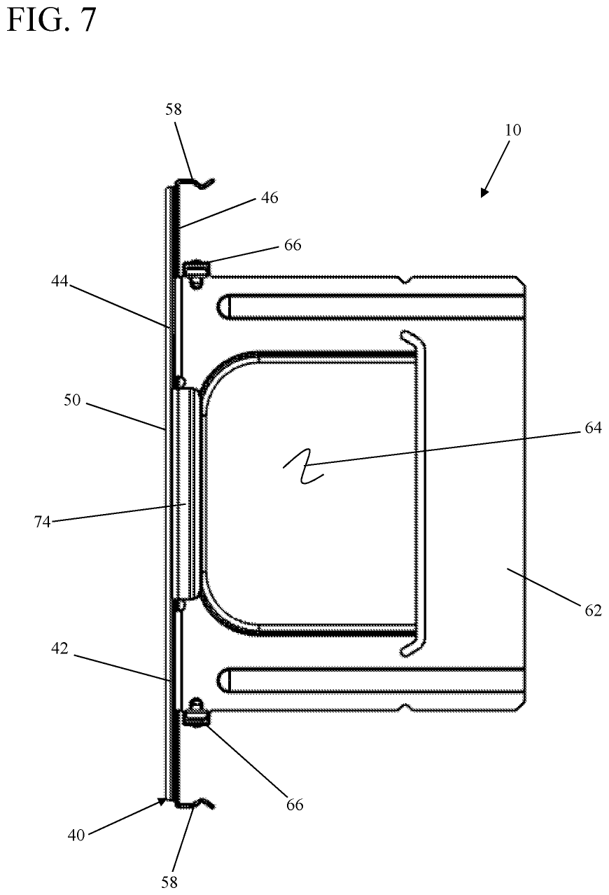

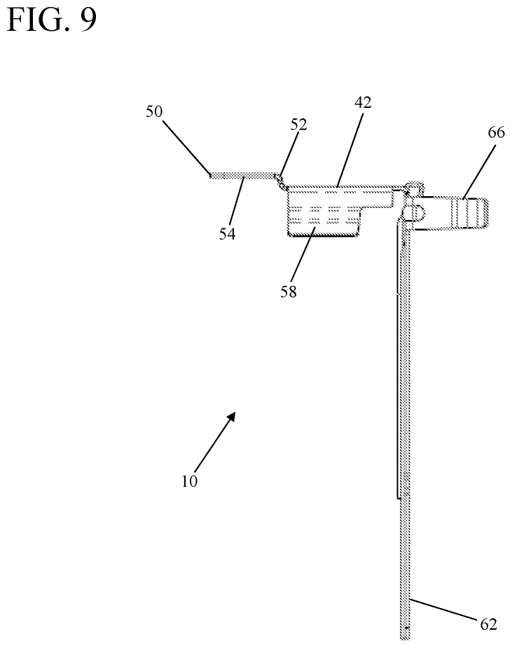

Referring to FIGS. 1-13, a first embodiment of a mounting bracket for use in mounting an electrical or communication device (or the like) between wall studs S (e.g., metal wall studs) is generally indicated at reference numeral 10. In this embodiment, the mounting bracket 10 is a unitary structure. The mounting bracket 10 may be formed from a single sheet metal (e.g., steel or aluminum) or other suitable material. In FIG. 1, a pair of mounting brackets 10 are included in a mounting bracket assembly 12 that spans between two wall studs S for mounting a multi-gang junction box J to the studs. In the illustrated embodiment, the assembly 12 includes a pair of telescoping brackets 14 comprising upper and lower channel members 16 spaced apart from each other, and stud mounting flanges 18 disposed at longitudinal ends of the channels for attaching the telescoping brackets to the studs S. The channel members 16 include holes 20 at spaced intervals along the length of the respective channel members. The mounting brackets 10 are attachable to the brackets 14 via the holes 20. As such, a first mounting bracket 10 may be attached to a first end margin of the telescoping brackets 14 and a second mounting bracket 10 may be attached to a second end margin of the telescoping brackets. The mounting brackets 10 couple the multi-gang junction box J to the telescoping brackets 14 thereby mounting the junction box to the studs S. Thus, in the illustrated embodiment, a pair of mounting brackets 10 are used in the mounting of the multi-gang junction box J to the studs S.

A box cover plate 22 (e.g., a plaster or mud ring or other ring structure) may be mounted against a front face of the mounting brackets 10 (FIG. 1). As is known in the art, mounting screws MS on the junction box J are received in slots in the box plate 22 and tightened to connect the box plate and the junction box to each other and to the mounting bracket assembly 12. As will be discussed in greater detail below, the mounting bracket 10 is configured to attach multi-gang junction boxes to a stud S in other configuration and to attach other types of junction boxes (i.e., single gang) without departing from the scope of the disclosure. An electrical or communications device (not shown) may also be secured in the junction box J. The orientation of the mounting bracket 10 in the drawings provides the point of reference for the terms defining relative locations and positions of structures and components of the bracket, including but not limited to the terms “upper,” “lower,” “left,” “right,” “top,” “bottom,” “forward,” and “rearward,” as used throughout the present disclosure.

The telescoping brackets 14 form a central opening that is sufficiently large enough to permit use of the mounting bracket assembly 12 with junction boxes J of different sizes. As an example, the assembly 12 is suitable for use with the junction boxes J having the following known sizes (dimension between upper and lower sides×dimension between left and right sides): 4×4 in, 4 11/16×4 11/16 in, and 5×5 in. Additionally, the assembly 12 is suitable for use with 2 gang, 3 gang, 4 gang, 5 gang, and 6 gang junction boxes. The assembly 12 is also configured to permit use of different types of box plates 22, such as, for example, a box cover plate having a rearward extending flange surrounding a central opening as described in U.S. Pat. No. 8,575,484, the entirety of which is hereby incorporated by reference, or a conventional plaster ring having a forward extending collar as shown in FIG. 1.

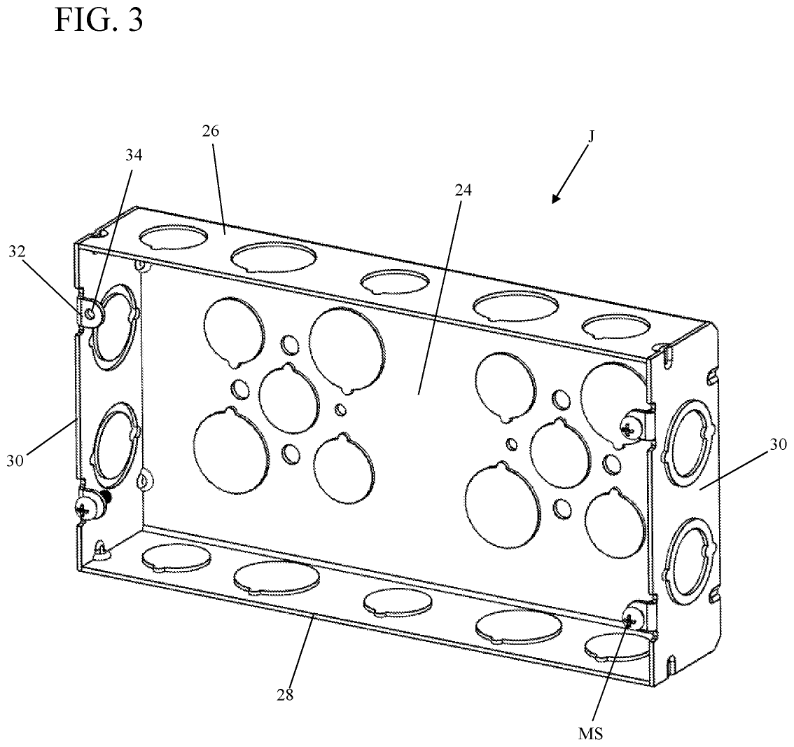

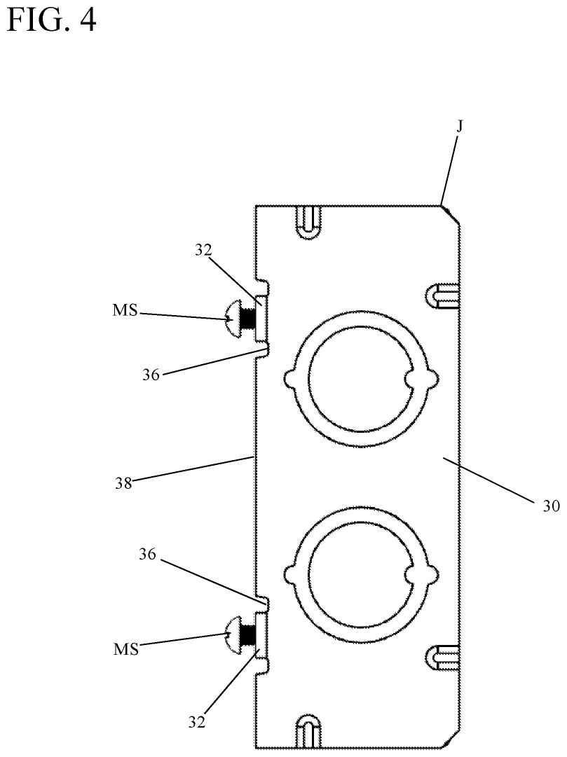

Referring to FIGS. 3 and 4, the multi-gang junction box J comprises a back wall 24, top and bottom walls 26, 28, respectively, projecting forward from the back wall, and a pair of side walls 30 extending between the top and bottom walls. Mounting tabs 32 extend inwardly from the side walls 30 and each define fastener holes 34. The mounting tabs 32 are received in recesses 36 in the front surface 38 of the side walls 30 such that outer surfaces of the mounting tabs are flush with the front surfaces of the side walls. The mounting screws MS are receivable in the fastener holes 34 in the mounting tabs 32 for mounting the junction box J to the bracket assembly 12. In the illustrated embodiment, the junction box J is a multi-gang junction box. Thus, the junction box J is configured to attach multiple electrical or communication devices to the junction box. As will be explained in greater detail below, the mounting brackets 10 are particularly, although not exclusively, configured for mounting junction boxes such as multi-gang junction box J to studs S for installing electrical or communication devices in a building.

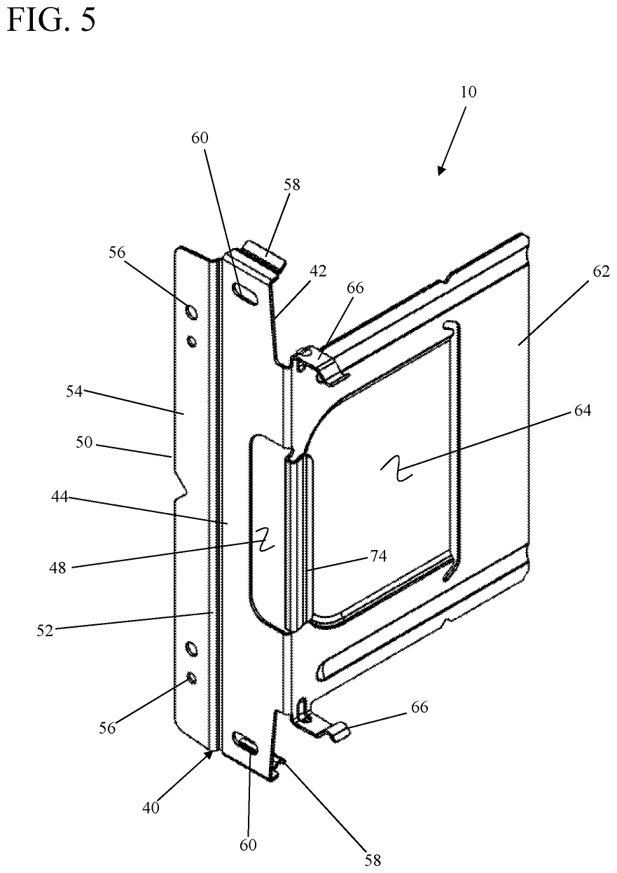

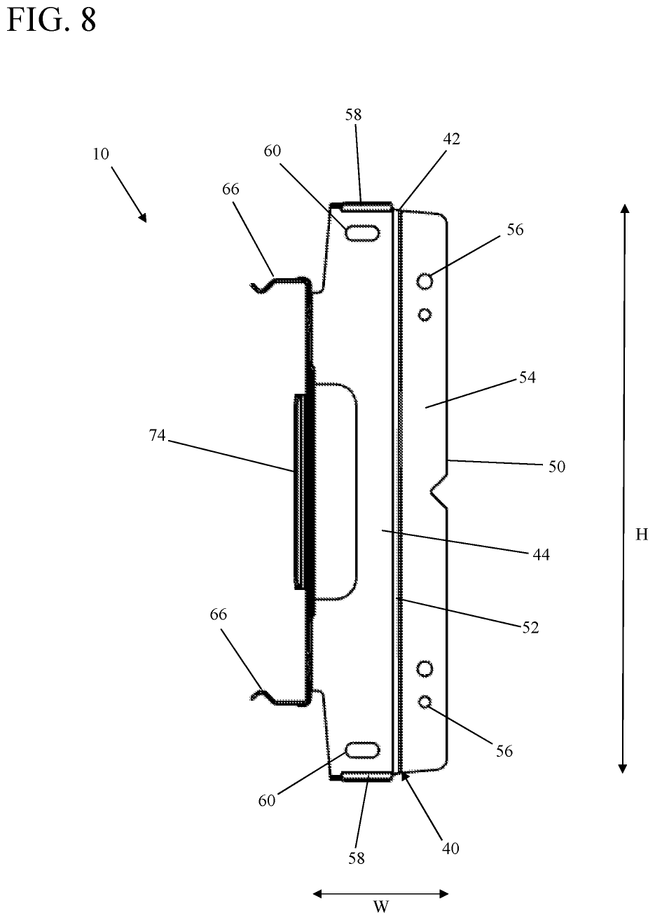

Referring still to FIGS. 5-11, each mounting bracket 10 includes a face plate, generally indicated at 40. The face plate 40 includes a main body 42 that is generally rectangular having opposite upper and lower edge margins, opposite left and right edge margins, a front face 44, a rear face 46, and, generally rectangular, cutout 48. The main body 42 comprising a generally elongate planar member. A left edge margin of the main body 42 extend generally parallel to vertical in the orientation shown in FIG. 5. A right edge margin of the main body 42 includes upper and lower sections that extend at angles to vertical, and a middle section that extends generally parallel to vertical. The cutout 48 is formed in the right edge margin of the main body 42 generally at the middle section and centered at about mid-height along the main body. The cutout 48 has a closed left side and an open right side. In the illustrated embodiment, the cutout 48 has a generally rectangular shape. However, the cutout 48 could have other shapes without departing from the scope of the disclosure. Alternatively, the cutout 48 could be omitted. In one embodiment, the face plate 40 has a height H extending between the upper and lower edge margins of about 6.5 inches, and a width W extending between the left and right edge margins of about 1.56 inches (FIG. 8).

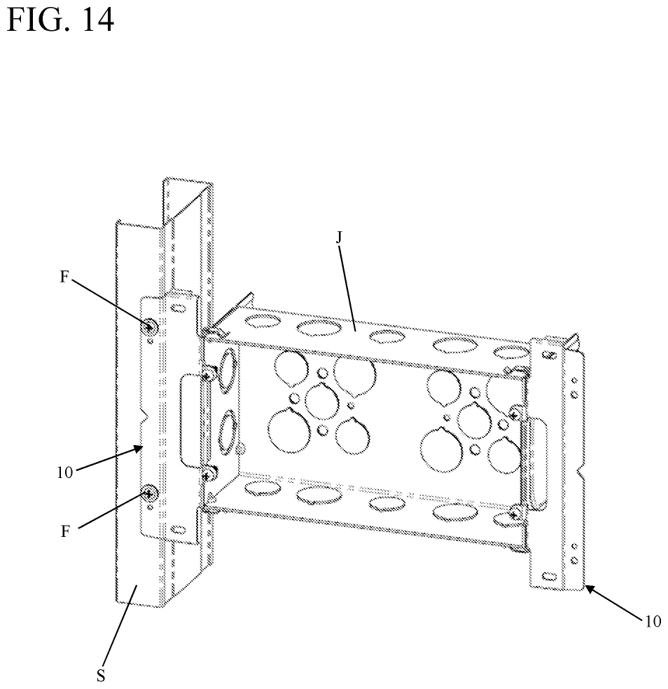

Referring to FIGS. 1, 5, 6, 8, and 9, a stud mounting flange 50 extends laterally outward from a left edge margin of the main body 42. In general, the stud mounting flange 50 is used to secure the mounting bracket 10 to a wall studs S using suitable fasteners F (e.g., standard self-tapping sheet metal screws in FIG. 14). However, in the illustrated embodiment, the flange 50 is used to attach the mounting bracket to one of the telescoping brackets 14. The mounting flange 50 includes a transition portion 52 extending directly from the main body 42 and an attachment portion 54 extending directly from the transition portion. The transition portion 52 extends forwardly from the main body 42 and the attachment portion 54 extends laterally from the transition portion such that attachment portion is offset forwardly from the main body 42. In the illustrated embodiment, the attachment portion 54 extends generally parallel to the main body 42 of the face plate 40. Fastener openings 56 are formed in the attachment portion 54 of mounting flange 50 for receiving fasteners F for attaching the mounting bracket 10 to a support structure (e.g., stud S, brackets 14, etc.).

Referring to FIGS. 5-9, mounting tabs 58 extend from upper and lower edge margins of the main body 42. The mounting tabs 58 are configured for snap engagement with the upper and lower channel members 16 of the telescoping brackets 14 to couple the mounting bracket 10 to the telescoping brackets. Slotted openings 60 are formed in the main body 42 generally at the upper and lower edge margins. The slotted openings 60 extend laterally across the main body 42 and can be aligned with one of the holes 20 in the channels 16. Thus, the slotted openings 60 are configured to receive fasteners F for fixedly attaching the mounting bracket 10 to the telescoping brackets 14.

Referring to FIGS. 5, 7, and 9, a far side support 62 extends rearwardly from the face plate 40. In the illustrated embodiment, the far side support 62 comprises a plate member having a generally rectangular shape. An opening 64 in formed in the far side support 62. The opening 64 has a generally mirrored D shape as shown in the view in FIG. 5. The far side support 62 is configured to extend along the side walls 30 and rear wall 24 of the junction box J to provide additional support to the junction box when the junction box is attached to the mounting bracket 10. For instance, the far side support 62 may have fold lines along a length of the support where the far side support can be bent to extend around the back and sides of the junction box J. The opening 64 in the far side support 62 may provide access to an interior of the junction box J from the side of the junction box for allowing wiring to be directed into and out of the junction box. The far side support 62 may have other configurations without departing from the scope of the disclosure. Alternatively, the far side support 62 may be omitted without departing from the scope of the disclosure.

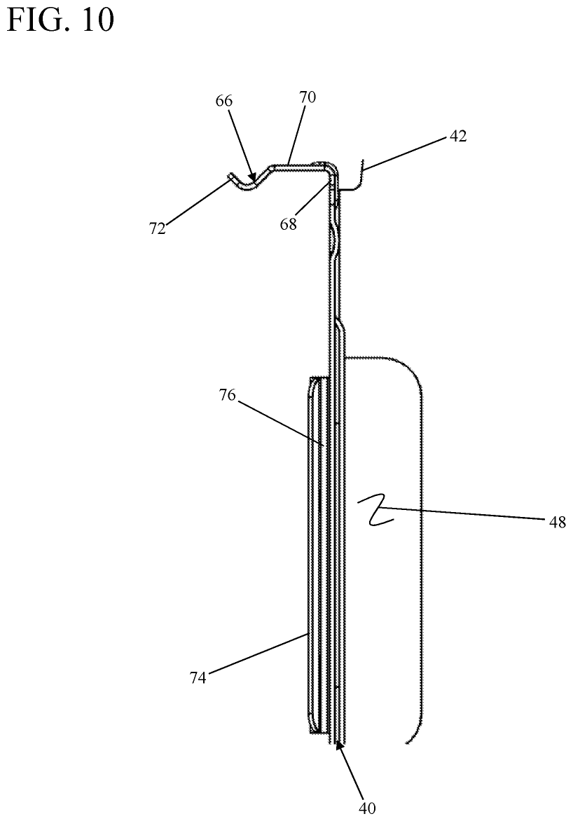

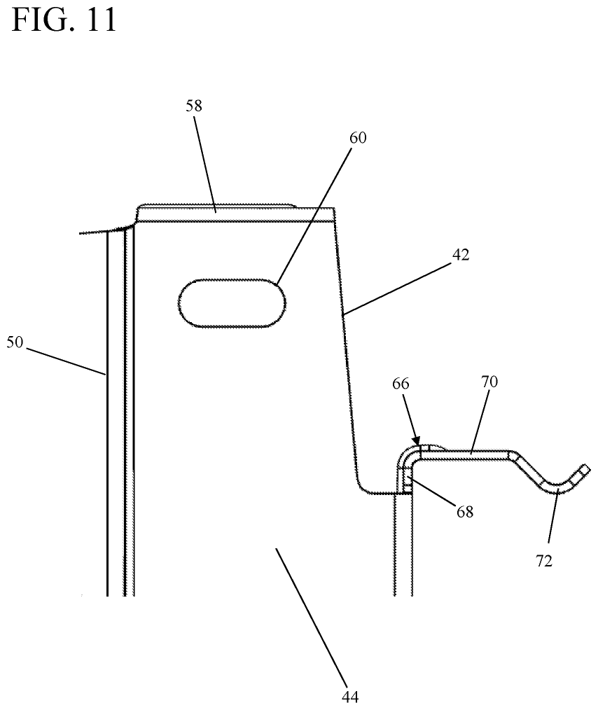

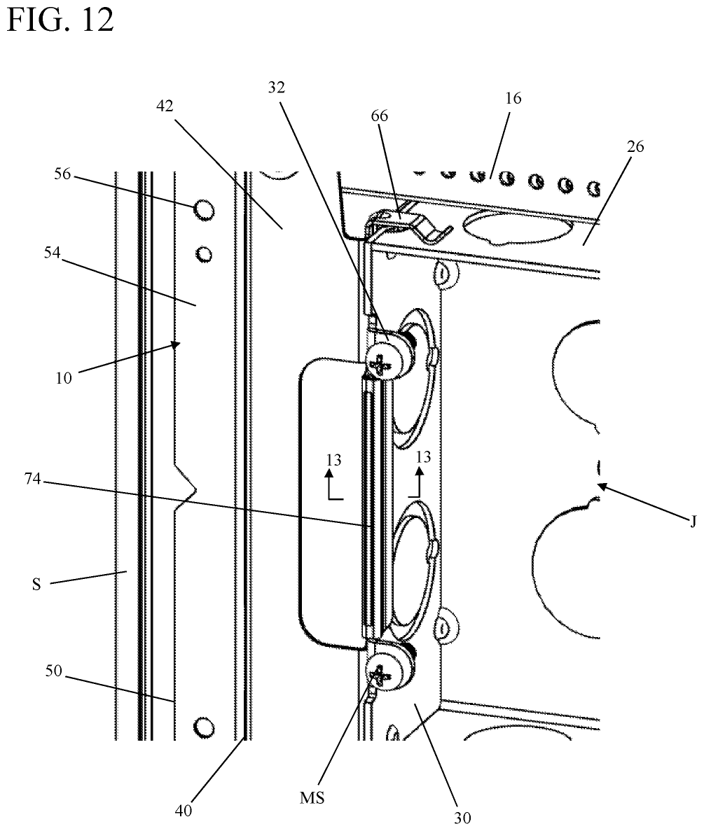

Referring to FIGS. 5-12, upper and lower flanges 66 (broadly, alignment flanges) extend laterally from a proximal end of the far side support 62. The flanges 66 extend generally away from the face plate 40 and are configured to engage a top and bottom of the junction box J to center and align the junction box on the mounting bracket 10. Each flange 66 comprises a first portion 68 that extends upward from the far side support 62 generally along a plane parallel to the far side support (FIGS. 10 and 11). A second portion 70 of the flange 66 extends laterally from the first portion 68. In the illustrated embodiment, the second portion 70 extends generally orthogonally to the first portion 68. A third portion 72 of the flange 66 extends from the second portion 70. The third portion 72 comprises an angled or curved section whereby the third portion initially extends downward from the second portion 20 and then extends (i.e., curves) upward to a terminal end of the third portion. Thus, the third portions 72 of the flanges 66 define a detent for engaging the junction box J to assist in holding the junction box in place on the mounting bracket 10 (FIG. 12). In particular, the third portion 72 of the upper flange 66 is configured to engage the top wall 26 of the junction box J and the lower flange 66 is configured to engage the bottom wall 28 of the junction box. Further, a spacing between the third portions 72 of the flanges 66 generally corresponds to the height of the junction box J so that the junction box can be received and centered between the flanges.

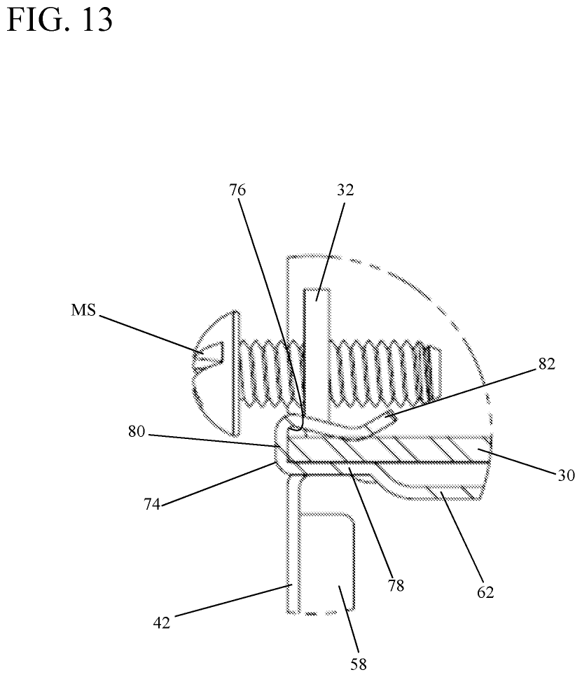

Referring to FIGS. 5-8, 10, 12, and 13, a clip 74 (broadly, a box mounting flange) extends from the far side support 62. The clip 74 is configured to receive and engage a portion of one of the side walls 30 of the junction box J to couple the mounting bracket 10 to the junction box. In the illustrated embodiment, the clip 74 extends generally forwardly from the proximal end of the far side support 62 and bends back upon itself forming a slot 76 (FIGS. 10 and 13). In particular, the clip 74 comprises a first portion 78 that projects forwardly from the far side support 62 and a second portion 80 that extends laterally from the first portion (FIG. 13). In the illustrated embodiment, the second portion 80 extends generally orthogonally to the first portion 78. A third portion 82 of the clip 74 extends rearwardly from the second portion 80. The third portion 82 of the clip 74 comprises an angled extension whereby a first part of the third portion extends toward the first portion 78 of the clip and a second part of the third portion extends away (i.e., bends away) from the first portion of the clip. Thus, the second portion 80 spaces the first and third portions 78, 82 away from each other forming the slot 76. Additionally, the bend between the first part of the third portion 82 and the second part of the third portion provides a contact location for engaging an inner surface of a side wall 30 of the junction box J when the side wall is received in the slot 76 of the clip 74. Similarly, an inner surface of the first portion 78 of the clip 74 is configured to engage an outer surface of the side wall 30 of the junction box J received in the slot 76. The clamping force generated by the clip 74 is sufficient to hold the weight of the junction box J to secure the junction box to the mounting bracket 10. This will allow the mounting bracket 10 to hold the junction box J in place while the box cover plate 22 is subsequently attached to the junction box. The upper and lower flanges 66 provide additional securement forces for holding the junction box J to the mounting bracket 10.

Referring to FIG. 13, the first portion 78 of the clip 74 extends forwardly from the far side support 62 such that an inner surface of the second portion 80 is generally coincident with an outer surface of the main body 42 of the face plate 40. Therefore, when the side wall 30 of the junction box J is received in the slot 76 of the clip 74, a front surface of the side wall 30 will be generally flush with the outer surface of the main body 42 of the face plate 40. This will eliminate any gaps between the cover plate 22 and the junction box J when the junction box J is coupled to the mounting bracket (i.e., when the side wall 30 is fully received in the slots 76 of the clip 74) and the cover plate is attached to the junction box. Thus, the mounting bracket 10 is configured to reduce the gap between the bracket and the cover plate 22 to comply with local electrical codes when a junction box J is mounted on the bracket. Also, when the cover plate 22 is removed, the junction box J will remain coupled to the mounting bracket 10 which provides user access to the junction box to complete wiring during field installation.

The mounting bracket 10 can be sold and shipped to customers separately or as part of an assembly, such as a pre-assembled electrical unit, or as part of a kit. In one embodiment, a mounting bracket assembly includes the mounting brackets 10 as described above, one or more junction boxes J for attachment to the mounting brackets, and one or more box cover plates 22 for attachment to the mounting brackets. The junction box(es) J and box cover plate(s) 32 can be attached to the mounting bracket 10 as-sold. Alternatively, the mounting brackets 10, junction box(es) J, and box cover plate(s) 22 can be sold together as a kit for assembly by the user. In another embodiment, a mounting bracket assembly includes a pair of mounting brackets 10, a junction box J, a box cover plate 22, and a pair of telescoping brackets 14, sold assembled or disassembled. In yet another embodiment, a mounting bracket assembly includes a pair of mounting brackets 10. Other configurations and assemblies are within the scope of the present invention.

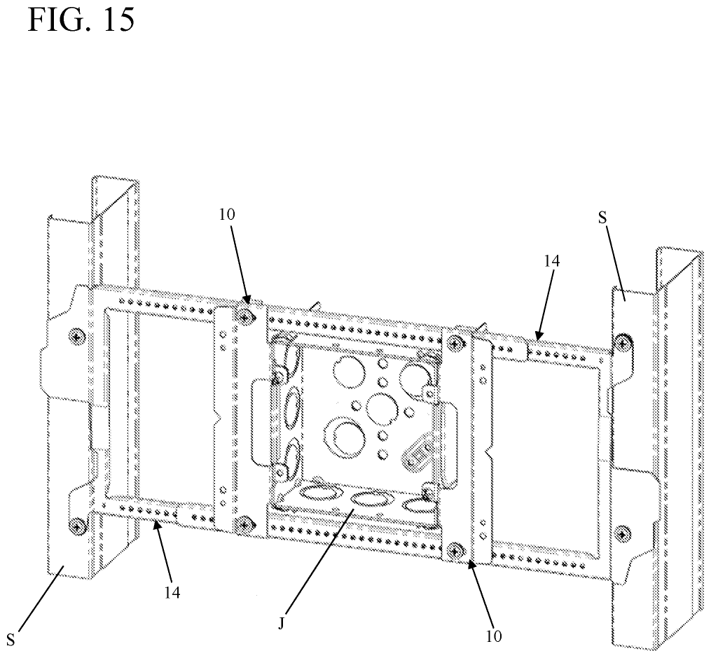

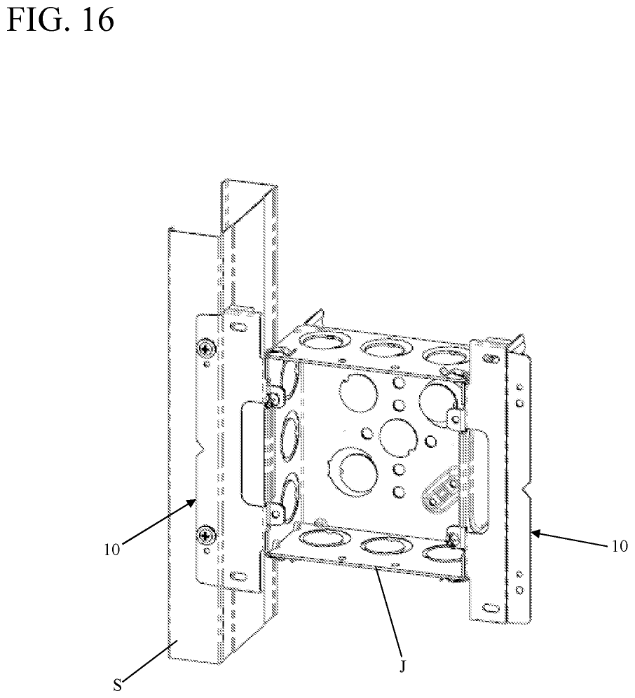

The mounting brackets 10 as described above are versatile and permit a user to use the bracket with various size junction boxes and various distances between adjacent wall studs. In particular, because the mounting brackets 10 are only attached at the sides of the junction box J, a single size mounting bracket can be used for various size junction boxes. Therefore, the mounting brackets 10 as described eliminate the need for different lengths of mounting brackets based on wall stud distance or different size mounting brackets based on junction box size. For instance, FIG. 14 shows the mounting bracket 10 attached directly to a wall stud S for mounting multi-gang junction box J to the stud. FIG. 15 shows mounting brackets 10 attached to telescoping brackets 14 for mounting a 4 11/16×4 11/16 junction box J to wall studs S. FIG. 16 shows mounting brackets 10 attached directly to a wall stud S for mounting a 4 11/16×4 11/16 junction box J to the wall stud.

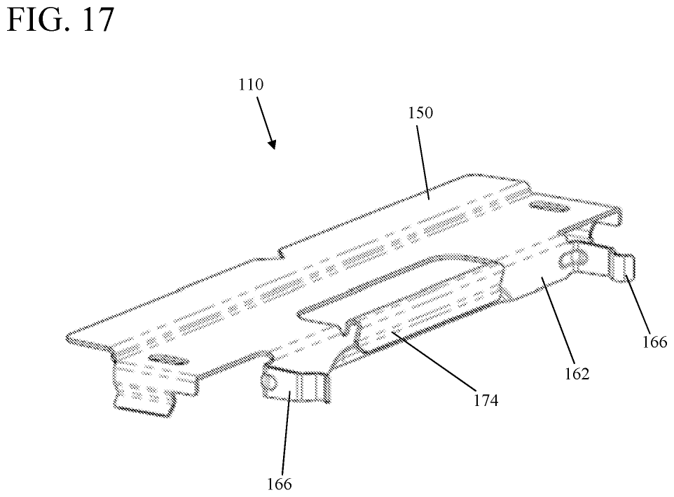

Referring to FIG. 17, a mounting bracket of another embodiment is generally indicated at 110. The mounting bracket 110 is substantially similar to the bracket 10. As such, like elements have been given like reference numbers plus 100. However, stud mounting flange 150 is free of any fastener openings. However, fastener opening may be provided. Additionally, far side support 62 on the bracket 10 has been remove in bracket 110. In its place, a support flange 162 has been provided. As such, the upper and lower flanges 166 and clip 174 extend from the support flange 150. The mounting bracket 110 otherwise functions substantially the same as mounting bracket 10.

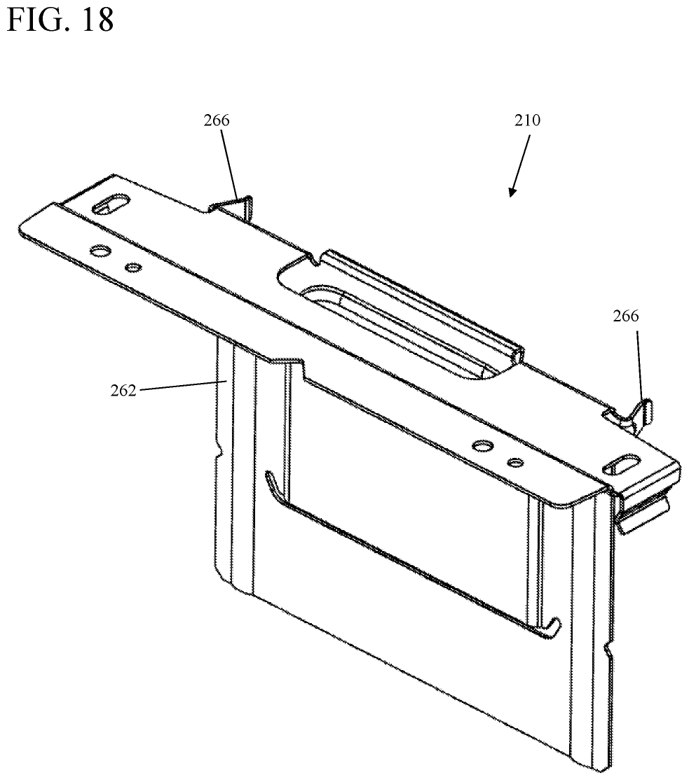

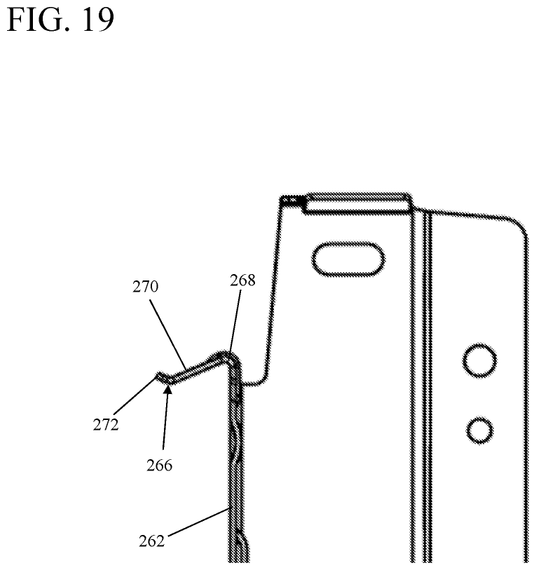

Referring to FIGS. 18 and 19, a mounting bracket of another embodiment is generally indicated at 210. The mounting bracket 210 is substantially similar to the bracket 10. As such, like elements have been given like reference numbers plus 200. However, upper and lower flanges 266 have a different configuration. In particular, each flange 266 comprises a first portion 268 that extends upward from the far side support 262 generally along a plane parallel to the far side support. A second portion 270 of the flange 266 extends laterally from the first portion 268. In the illustrated embodiment, the second portion 270 extends generally at an acute angle to the first portion 268 such that the second portion of the upper flange 266 extends downward and away from the first portion and the second portion of the lower flange 266 extends upward and away from the first portion. A third portion 272 of the flange 266 extends from the second portion 270. The third portion 272 comprises a planar section. The third portion 272 of the upper flange 266 extends upward from the second portion 270, and the third portion of the lower flange 266 extend downward from the second portion. Thus, bends between the second portions 270 and the third portions 272 of the flanges 266 define detents for engaging the junction box J to assist in holding the junction box in place on the mounting bracket 10. The mounting bracket 210 otherwise functions substantially the same as mounting bracket 10.

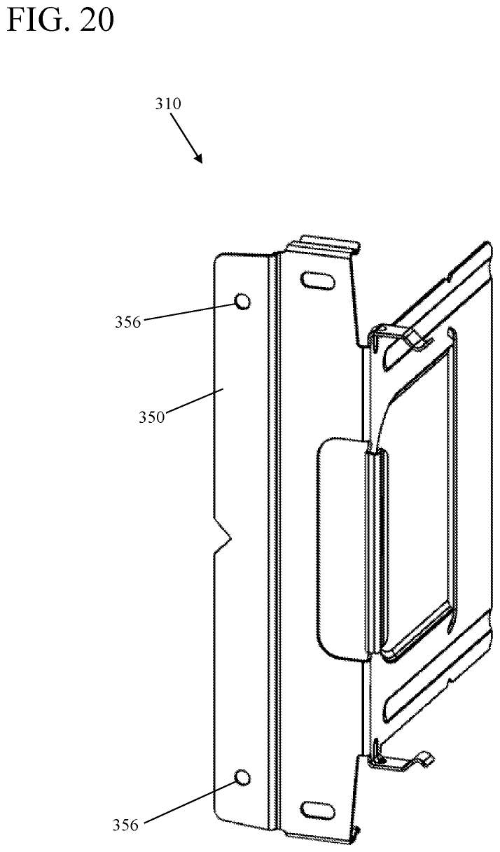

Referring to FIG. 20, a mounting bracket of another embodiment is generally indicated at 310. The mounting bracket 310 is substantially similar to the bracket 10. As such, like elements have been given like reference numbers plus 300. However, stud mounting flange 350 includes only two fastener openings 356. The mounting bracket 310 otherwise functions substantially the same as mounting bracket 10.

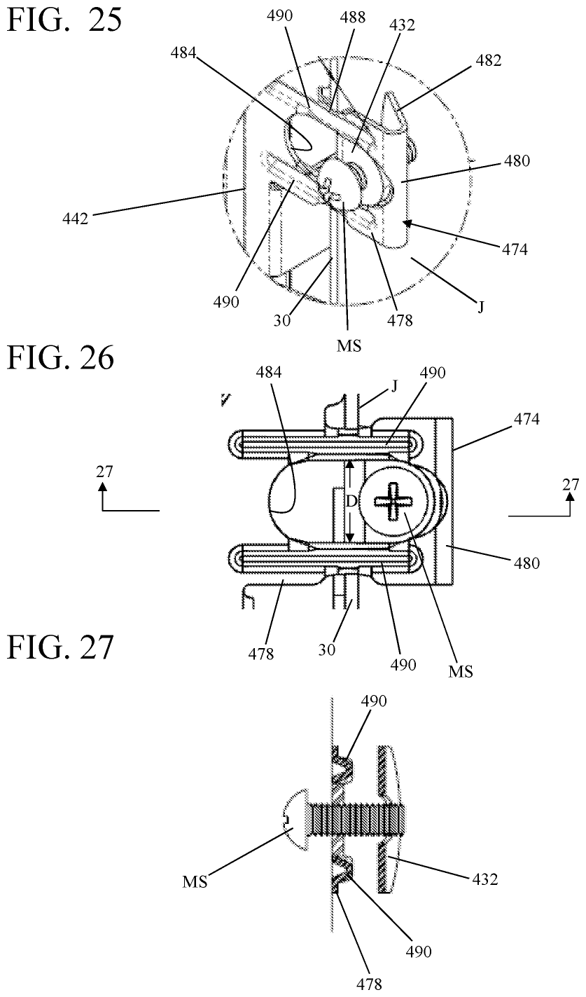

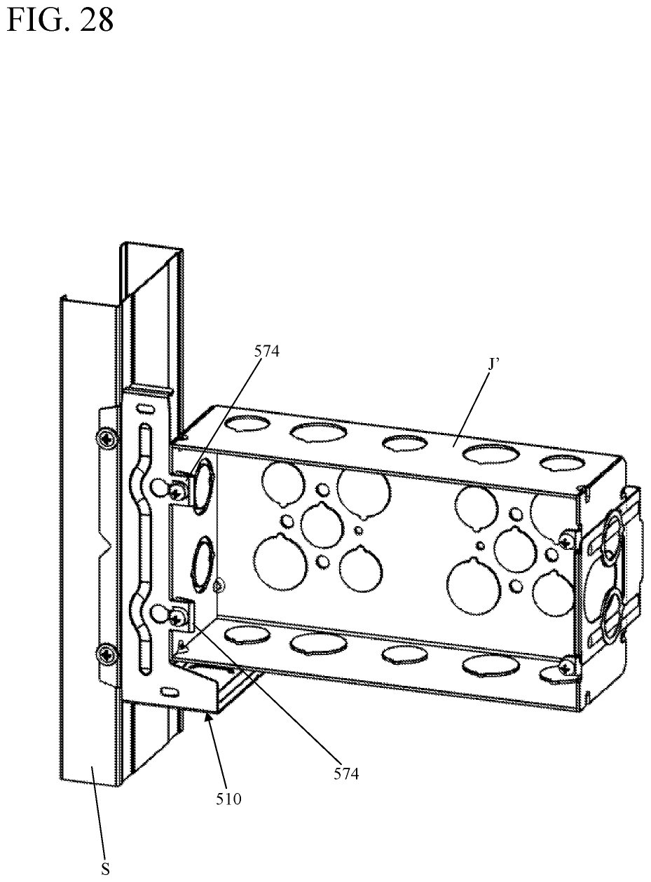

Referring to FIGS. 21-27, another embodiment of a mounting bracket is generally indicated at 410. The mounting bracket 410 is similar to the bracket 10 in the previous embodiment. As such, like elements have been given like reference numbers plus 400. In the illustrated embodiment, a pair of mounting brackets 410 are included in a mounting bracket assembly 412 that spans between two wall studs S for mounting a multi-gang junction box J to the studs. The assembly 412 includes a pair of telescoping brackets 414. A first mounting bracket 410 may be attached to a first end margin of the telescoping brackets 414 and a second mounting bracket 410 may be attached to a second end margin of the telescoping brackets. The mounting brackets 410 couple the multi-gang junction box J to the telescoping brackets 14 thereby mounting the junction box to the studs S. Thus, in the illustrated embodiment, a pair of mounting brackets 410 are used in the mounting of the multi-gang junction box J to the studs S.

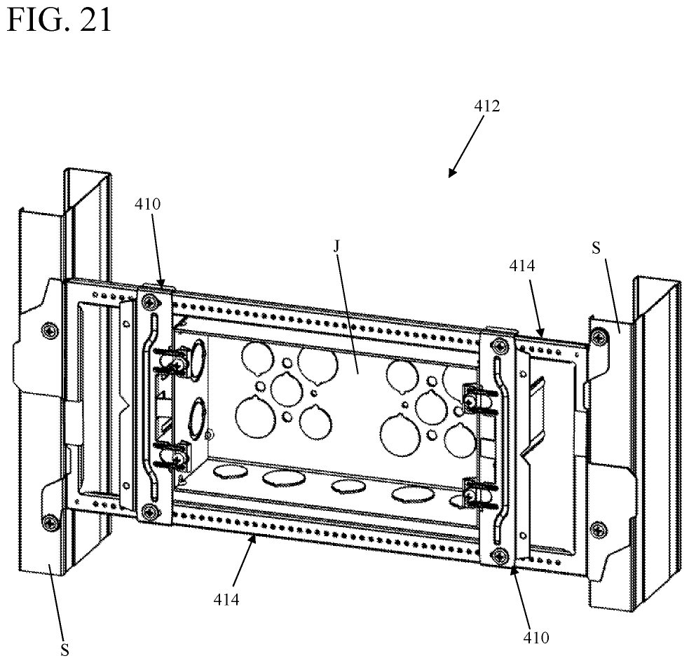

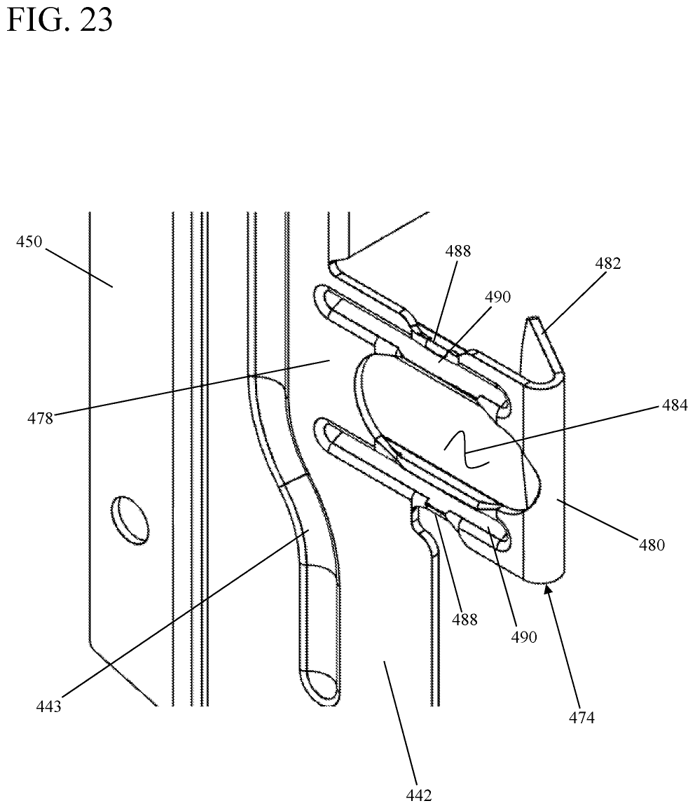

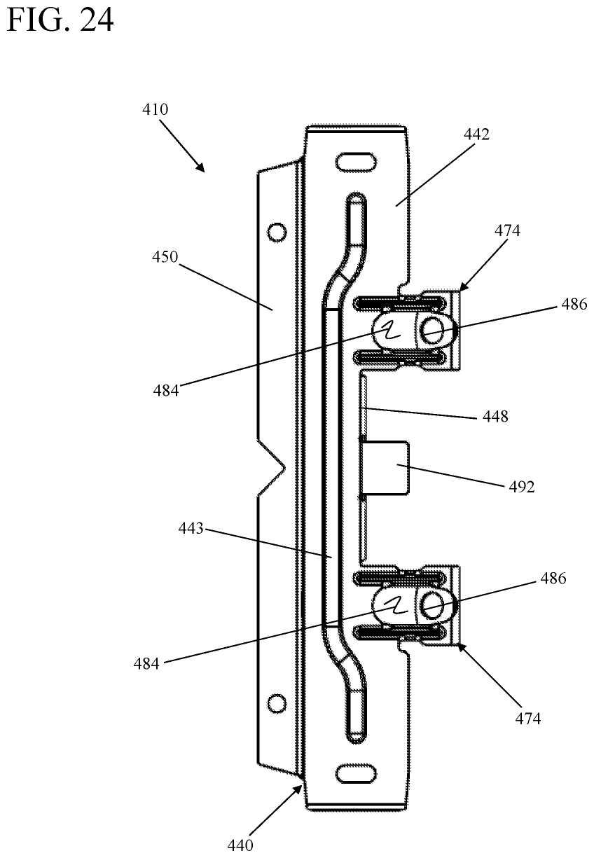

Referring still to FIGS. 22-24, each mounting bracket 410 comprises a face plate 440 including a main body 442 that is generally rectangular having opposite upper and lower edge margins and opposite left and right edge margins. The main body 442 comprises a generally elongate planar member with a stiffening rib 443 extending along a height of the main body. A cutout 448 is formed in the right edge margin of the main body 442 (FIG. 24). A left edge margin of the main body 442 extends generally parallel to a vertical in the orientation shown in FIG. 22. Mounting tabs 458 extend from upper and lower edge margins of the main body 442. The mounting tabs 458 are configured for snap engagement with the upper and lower channel members of the telescoping brackets 414 to couple the mounting bracket 410 to the telescoping brackets. A far side support 462 extends rearwardly from the face plate 440. In the illustrated embodiment, the far side support 462 comprises a plate member having a generally rectangular shape.

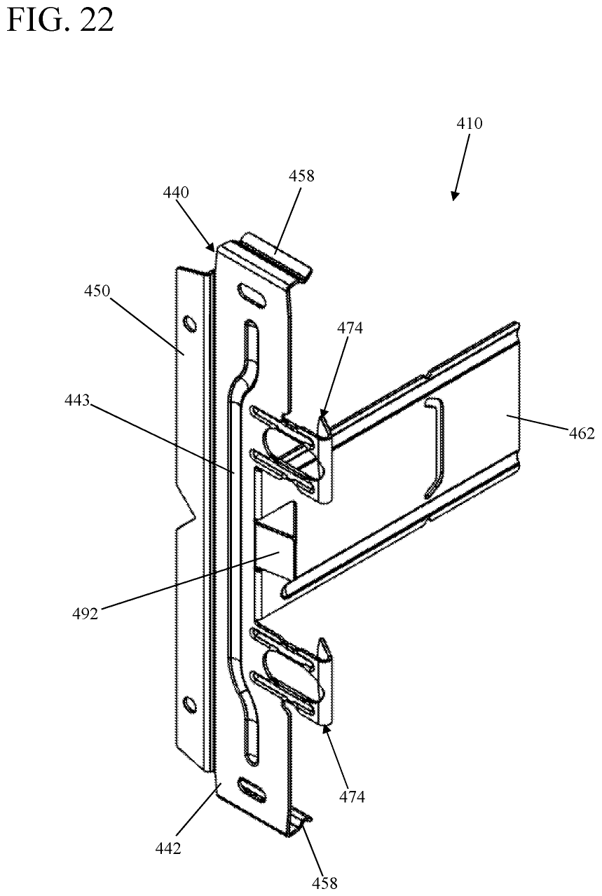

Referring to FIGS. 22-27, a pair of box mounting flanges 474 extend laterally from the right edge margin the main body 442. The flanges 474 is configured to interact with the junction box J, including the mounting tabs 32 on the junction box, to couple the mounting bracket 10 to the junction box. In the illustrated embodiment, each flange 474 extends generally laterally away from the main body 442 and bends back upon itself and extends back toward the main body. In particular, each flange 474 comprises a first portion 478 that projects directly from the main body 442, a second portion 480 that extends laterally from the first portion, and a third portion 482 that extends from the second portion (FIG. 23). In the illustrated embodiment, the first portion 478 comprises an elongate plate member and defines a slotted opening 484 extending along a length of the plate member. The second portion 480 comprises a curved member that curves rearwardly from the first portion 478. The third portion 482 of the flange 474 comprises a planar member and extends rearwardly from the second portion 480 back toward the main body 442. Thus, the second portion 480 defines a bend between the first and third portion 478, 482. The third portion 482 also defines an opening 486 that is generally aligned with the slotted opening 484 in the first portion 478 (FIG. 24). In the illustrated embodiment, the opening 486 is circular. However, the openings 484, 486 could have other configurations without departing from the scope of the disclosure.

Referring to FIGS. 23 and 25-27, indentations 488 are formed in the outer edges of the first portions 478 of the flanges 474 generally opposite a middle of the openings 484. Because the opening 484 narrows the material of the flange 474 on opposite sides of the opening, stiffening ribs 490 may extend along the length of the first portion 478 opposite the opening to reinforce the flange around the opening. Coupling of the mounting bracket 10 to a junction box J is accomplished by tilting the bracket away from a neutral position (i.e., face plate 440 generally parallel with the front surface of the junction box) to align the shafts of the mounting screws MS on the junction box with the openings 486 in the third portions 482 of the flanges 474. The shafts are inserted into the openings 486 a sufficient distance to provide clearance for the brackets 10 to be tilted back to the neutral position. The slotted openings 484 in the first portions 478 of the flanges 474 have a vertical dimension D that is larger than a diameter of the head of the mounting screw MS and larger than a height of the mounting tabs 32 permitting the flanges to be pivoted over the heads of the mounting screws and mounting tabs to reorient the bracket 10 in the neutral position (FIG. 26). In the neutral position, the areas of the first portion 478 having the indentations 488 are received in the recesses 36 in the side wall 30 of the junction box J, above and below the mounting tabs 32, and contact the inside of the recesses to allow the front surface of the bracket (e.g., front face of main body 442) to be flush with the front surface of the junction box. This will eliminate any gaps between the cover plate 22 and the junction box J when the junction box J is coupled to the mounting bracket 410 and the cover plate is attached to the junction box. Thus, the mounting bracket 410 is configured to reduce the gap between the bracket and the cover plate 22 to comply with local electrical codes when a junction box J is mounted on the bracket.

Referring to FIGS. 22 and 24, a support tab 492 projects laterally from the main body 492 of the face plate 490. The support tab 492 extends generally parallel to the main body 492 such that when the bracket 410 is attached to the junction box J, the support tab is configured to engage an outer surface of the side wall 30 of the junction box. Thus, the support tab 492 provides resistance to lateral movement of the junction box J relative to the mounting bracket 410. In the illustrated embodiment, the support tab 492 comprises a rectangular member. However, the support tab 492 may have other configurations without departing from the scope of the disclosure. Alternatively, the support tab 492 may be omitted.

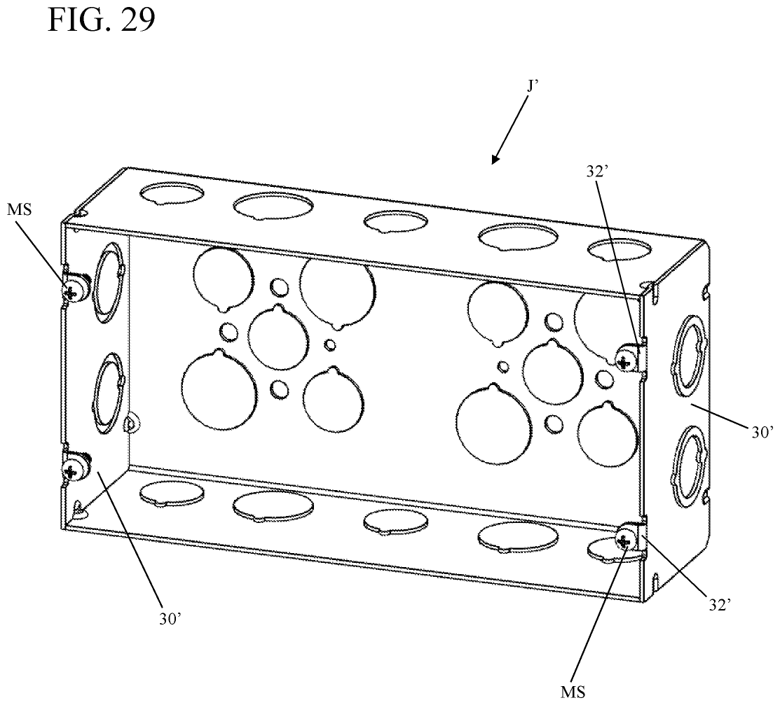

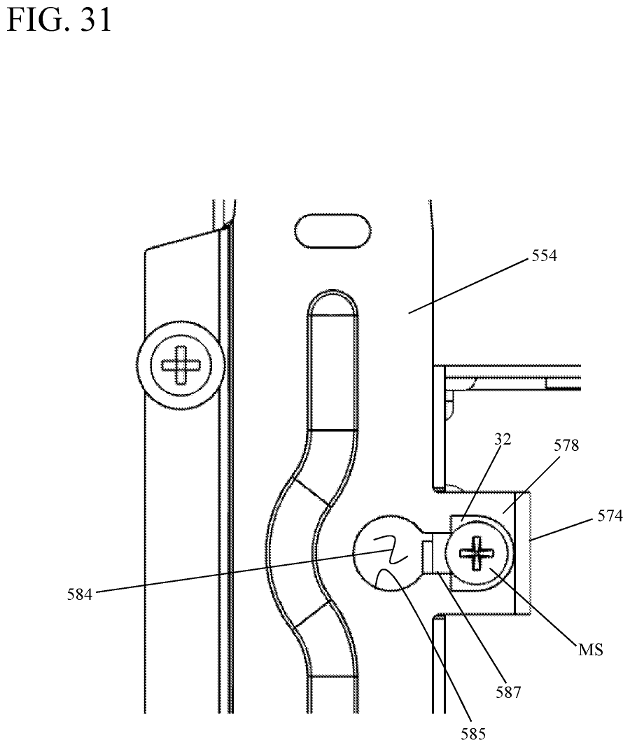

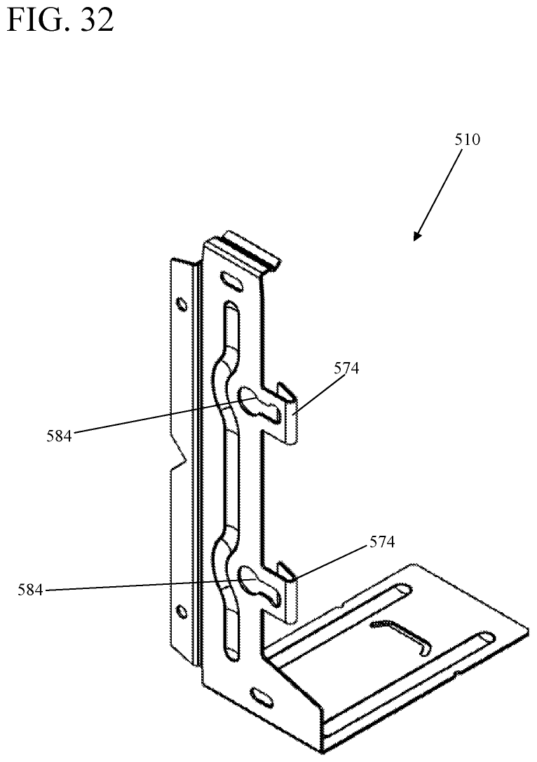

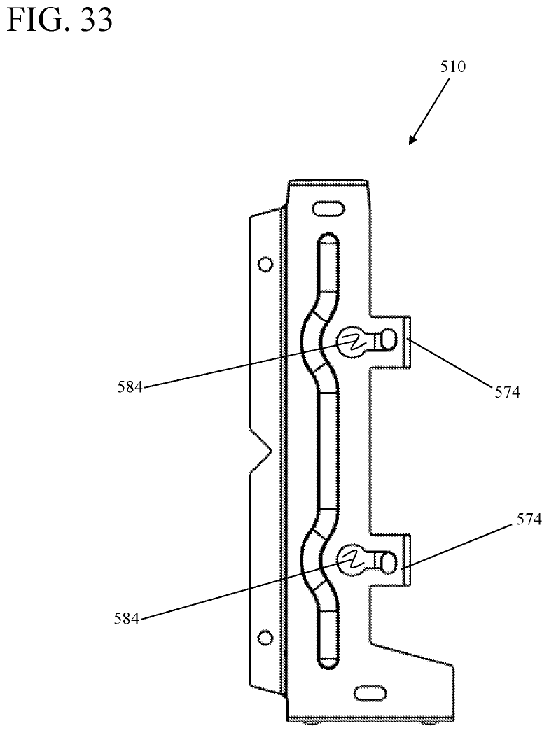

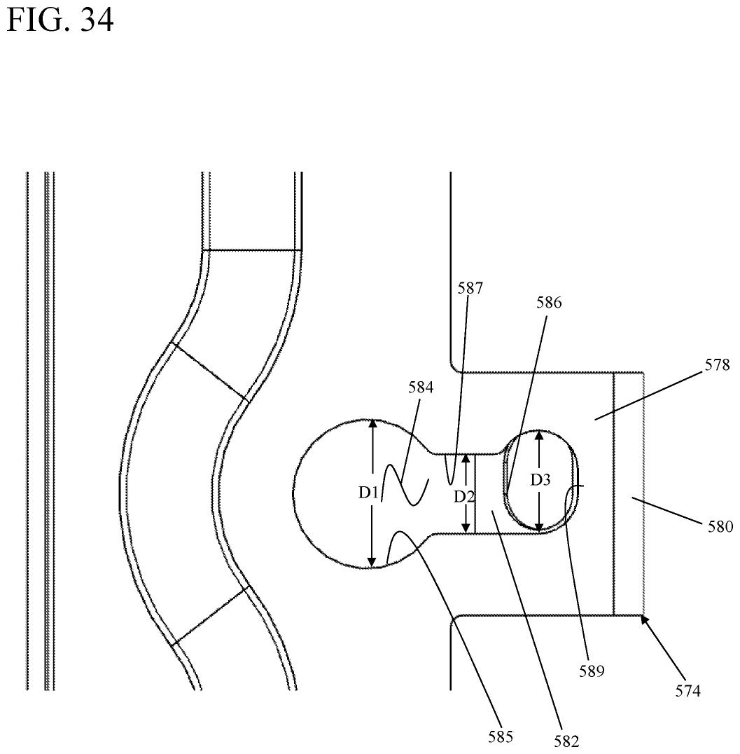

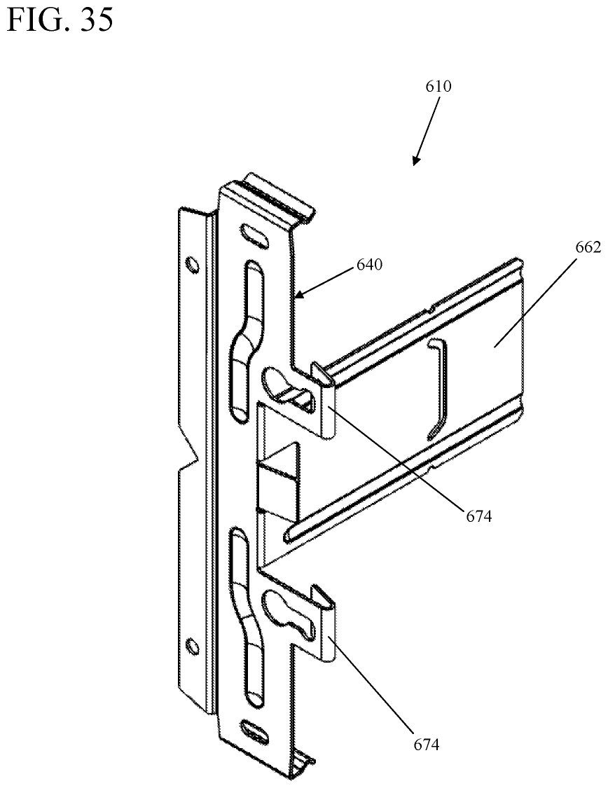

Referring to FIGS. 28-34, a mounting bracket of another embodiment is generally indicated at 510. The mounting bracket 510 is substantially similar to the bracket 410. As such, like elements have been given like reference numbers plus 100. However, box mounting flanges 574, and in particular, the openings 584 in the flanges have a different configuration. In the illustrated embodiment, the openings 584 comprise slotted openings having different cross-sectional dimensions along a length of the opening. The openings 584 include a first bulbous portion 585 disposed at a first longitudinal end of the opening, a middle transition portion 587 communicating with the first bulbous portion at one side of the transition portion, and a second bulbous portion 589 disposed at a second longitudinal end of the opening and communicating with the transition portion at a second side of the transition portion. The first bulbous portion 585 has a generally circular shape. The first portion 585 has a maximum cross-sectional dimension D1 extending orthogonal to a longitudinal axis of the opening 584 (FIG. 34). The second portion 587 of the opening 584 has an open-ended rectangular shape. The second portion 587 has a maximum cross-sectional dimension D2 extending orthogonal to the longitudinal axis of the opening 584 that is smaller than the maximum cross-sectional dimension D1 of the first portion 858. Thus, the second portion 587 tapers down in opening size from the first portion 585. The third portion 589 has an oblong racetrack shape that extends generally in a direction orthogonal to the longitudinal axis of the opening 584. The third portion 589 has a maximum cross-sectional dimension D3 extending orthogonal to the longitudinal axis of the opening 584 that is larger than the maximum cross-sectional dimension D2 of the second portion 587 but smaller than the maximum cross-sectional dimension D1 of the first portion 585. Therefore, in use, the head of the mounting screw MS is sized to be received in the first portion 585 and the shaft of the mounting screw can be slid along the second portion 587 and into the third portion 589. However, the size of the third portion 589 is not larger enough to permit the head of the mounting screw MS to be pulled through the third portion. Thus, the mounting screws MS can be tightened onto the flanges 574 when the mounting screws are in the third portions 589 of the openings 584 to secure the flanges to the mounting flanges 32 of the junction box J′. In this position, the mounting flanges 32 will be captured between the first portions 578 and the third portions 582 of the flanges 574.

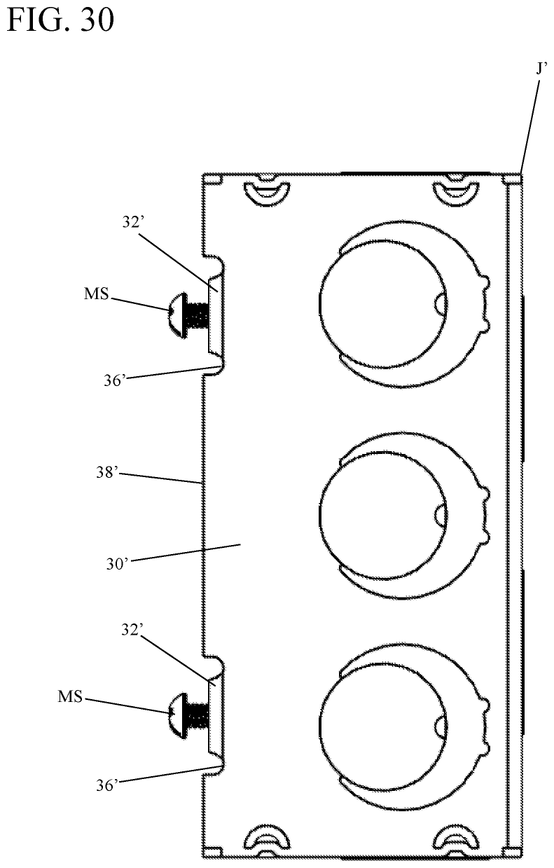

Referring to FIGS. 29 and 30, similar to junction box J in the previous embodiment, junction box J′ includes mounting tabs 32′ that extend inward from the side walls 30′ and are received in recesses 36′ in the front surface 38′ of the side walls 30′. However, the mounting tabs 32′ are inset from the front surface 38′ of the side walls 30′ so that outer surfaces of the mounting tabs are also recessed from the front surfaces of the side walls. Therefore, when the junction box J is coupled to the mounting bracket 10, the first portions 578 of the flanges 574 are received in the recesses 36′ in the junction box J′. Therefore, an outer surface of the face plate 540 will be flush with the outer surface 38′ of the junction box. As with the previous embodiments, the mounting screws MS are receivable in fastener holes in the mounting tabs 32′ for mounting the junction box J′ to the mounting bracket 10.

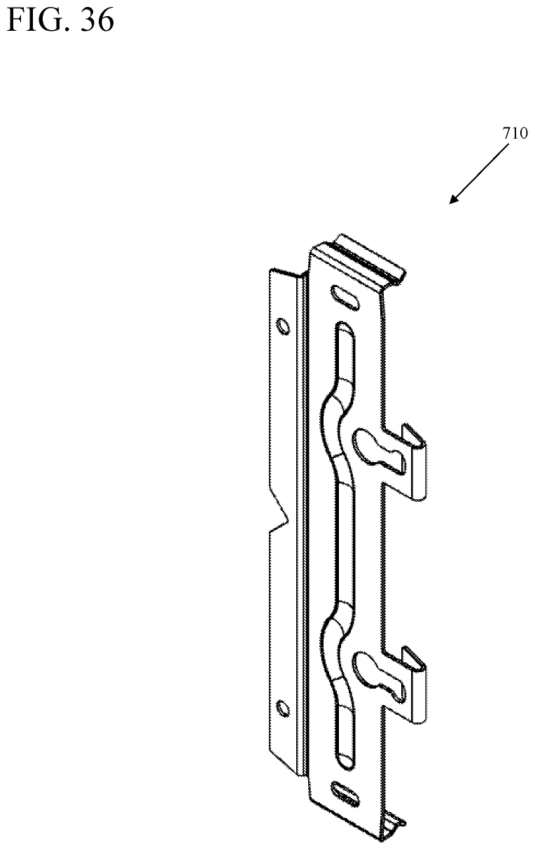

Referring to FIG. 35, a mounting bracket of another embodiment is generally indicated at 610. The mounting bracket 610 is substantially similar to the bracket 510. As such, like elements have been given like reference numbers plus 100. However, far side support 662 extends from a middle of face plate 640. The mounting bracket 610 otherwise functions substantially the same as mounting bracket 510.

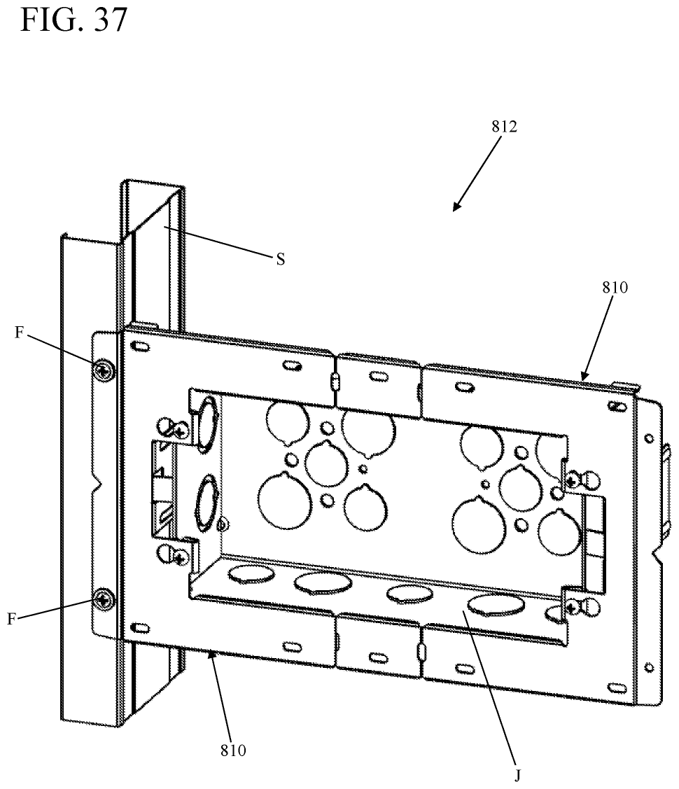

Referring to FIG. 36, a mounting bracket of another embodiment is generally indicated at 710. The mounting bracket 710 is substantially similar to the bracket 510. As such, like elements have been given like reference numbers plus 200. However, the mounting bracket 710 is free of a far side support. The mounting bracket 710 otherwise functions substantially the same as mounting bracket 510.

Referring to FIGS. 37-39, another embodiment of a mounting bracket is generally indicated at 810. The mounting bracket 810 is similar to the bracket 610 in the previous embodiment. As such, like elements have been given like reference numbers plus 200. In the illustrated embodiment, a pair of mounting brackets 810 are included in a mounting bracket assembly 812 that are configured to span between two wall studs S (only one is shown) for mounting a multi-gang junction box J to the studs. A first mounting bracket 810 may be attached directly to a first stud S and a second mounting bracket 810 may be attached directly to a second stud (not shown). The mounting brackets 810 thereby mount the junction box to the studs S. Thus, in the illustrated embodiment, a pair of mounting brackets 810 are used in the mounting of the multi-gang junction box J to the studs S.

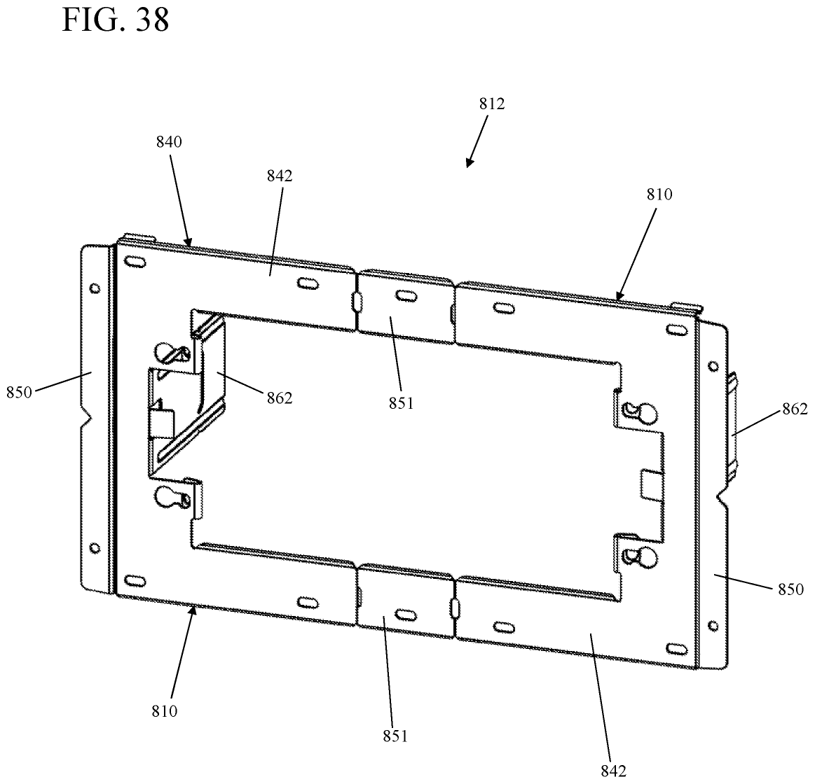

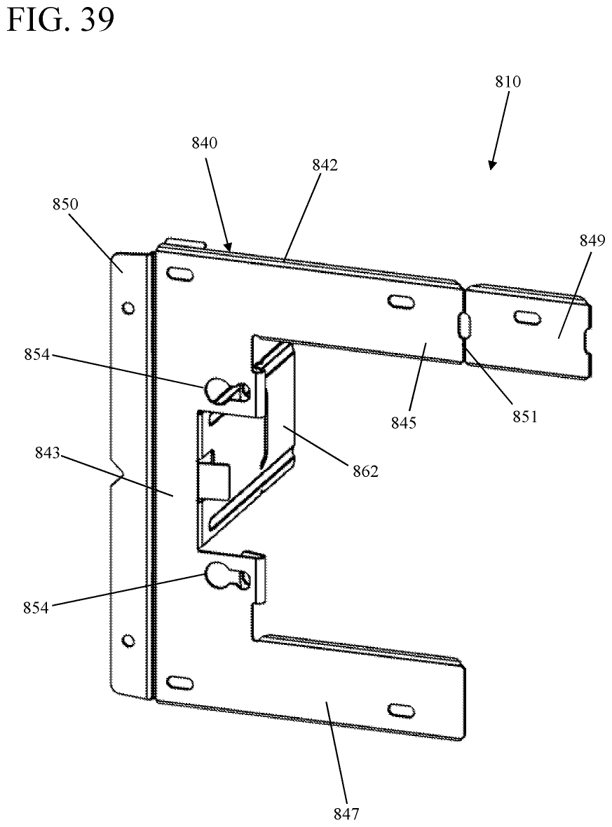

Referring to FIGS. 38 and 39, each mounting bracket 810 comprises a face plate 840 including a main body 842 that is generally C-shaped having opposite upper and lower edge margins and opposite left and right edge margins. The C-shaped main body 842 includes a vertically extending base 843, an upper extension arm 845 extending laterally from a top of the base, and a lower extension arm 847 extending laterally from a bottom of the base (FIG. 39). An extension tab 849 is removably attached to a distal end of the upper extension arm 845. In the illustrated embodiment, the extension tab 849 is attached to the upper extension arm 845 along a break line 851. The extension tables 849 can be removed to size the mounting brackets 810 for a smaller junction box J. A stud mounting flange 850 extends laterally outward from a left edge margin of the main body 842. In general, the stud mounting flange 850 is used to secure the mounting bracket 810 to a wall studs S using suitable fasteners F. A far side support 862 extends rearwardly from the face plate 840. In the illustrated embodiment, the far side support 862 comprises a plate member having a generally rectangular shape.

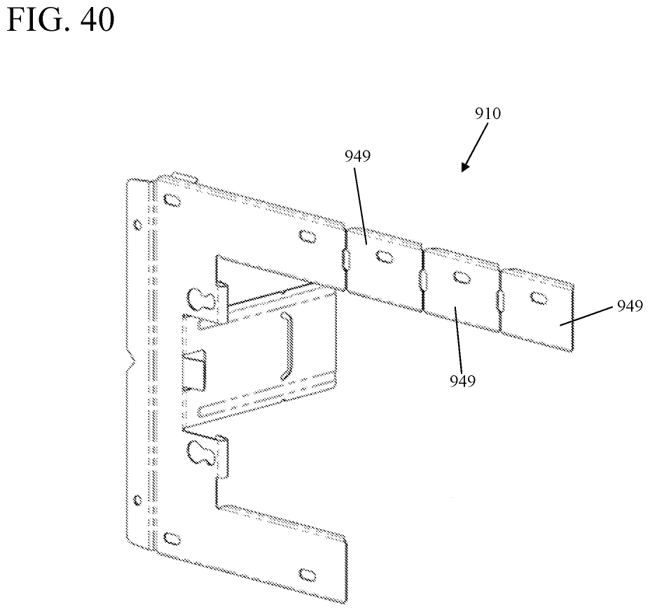

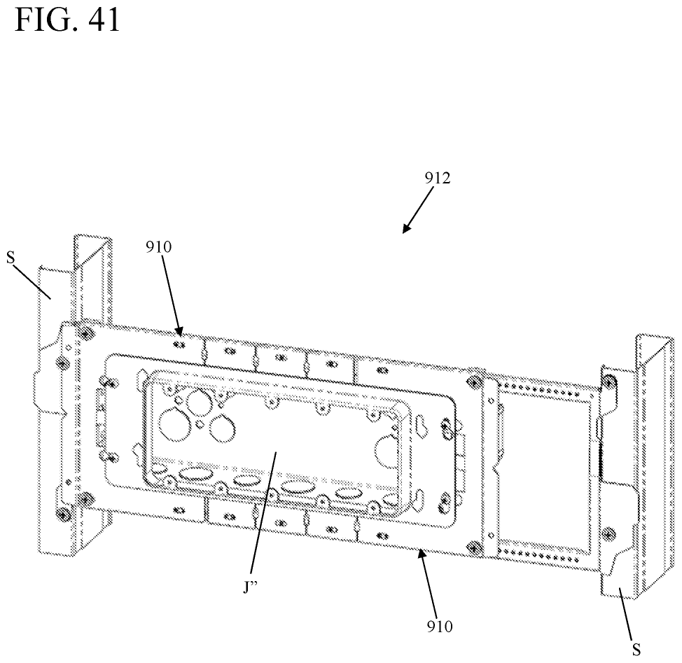

In the embodiment shown in FIG. 37, the first mounting bracket 810 attached to the stud S is oriented where the extension tab 849 extends from the upper extension arm 845. However, the second mounting bracket 810 has been flipped to mate with the first mounting bracket so that the extension tab 849 extends from the lower extension arm 847. This bracket assembly 812 is sized for the junction box J. However, FIGS. 40 and 41 show an alternative embodiment of a mounting bracket 910 including three (3) extension tabs 949. Thus, a bracket assembly 912 including a pair of mounting brackets 910 is configured to attach junction box J″ to wall studs S. Similar to mounting bracket 810, the extension tabs 949 can be removed to size down the mounting brackets 910 to fit the desired junction box J.

Having described embodiments of the invention in detail, it will be apparent that modifications and variations are possible without departing from the scope of the invention defined in the appended claims.

When introducing elements of the present invention or the illustrated embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A mounting bracket for attaching a junction box to a wall stud comprising:
a face plate having opposite upper and lower edge margins and opposite left and right edge margins;
a stud mounting flange extending laterally from the left edge margin of the face plate and configured for attaching the mounting bracket to the wall stud; and
a box mounting flange attached to the right edge margin of the face plate, the box mounting flange being configured to engage a side wall of the junction box to couple the junction box to the mounting bracket.

2. The mounting bracket of claim 1, wherein when the box mounting flange is in engagement with the side wall of the junction box, a front surface of the face plate is flush with a front surface of the junction box.

3. The mounting bracket of claim 2, wherein the box mounting flange comprises a clip configured to clip onto the side wall of the junction box and engage inner and outer side surfaces of the side wall to retain the junction box to the mounting bracket.

4. The mounting bracket of claim 1, wherein the stud mounting flange is free of openings for receiving mounting screws to attach the mounting bracket to the junction box when the box mounting flange is engaged with the junction box.

5. The mounting bracket of claim 1, further comprising alignment flanges attached to the face plate, a first alignment flange being configured to engage a top wall of the junction box and a second alignment flange being configured to engage a bottom walls of the junction box to align and center the junction box on the mounting bracket when the junction box is coupled to the mounting bracket.

6. The mounting bracket of claim 1, further comprising a far side support extending rearwardly from the face plate.

7. The mounting bracket of claim 1, further comprising mounting tabs extending rearwardly from upper and lower edge margins of the face plate.

8. The mounting bracket of claim 1, wherein the face plate has a generally rectangular shape.

9. The mounting bracket of claim 1, further comprising a pair of box mounting flanges, each box mounting flange defining an opening for receiving a mounting screw to couple the junction box to the mounting bracket.

10. The mounting bracket of claim 9, wherein the opening is slotted.

11. The mounting bracket of claim 9, wherein each box mounting flange comprises a first portion projecting directly from the face plate, a second portion extend laterally from the first portion, and a third portion extending from the second portion back toward the face plate.

12. The mounting bracket of claim 11, wherein the first portion comprises an elongate plate member and defines the slotted opening, the second portion comprising a curved member, and the third portion comprising a planar member.

13. The mounting bracket of claim 12, wherein the third portion defines an opening.

14. The mounting bracket of claim 9, further comprising a support tab projecting laterally from the face plate, the support tab being configured to engage an outer surface of a side wall of the junction box when the junction box is coupled to the mounting bracket.

15. A method of coupling a mounting bracket to a junction box comprising:
engaging a side wall of the junction box with a box mounting flange of the mounting bracket such that i) a front surface of a face plate of the mounting bracket is flush with a front surface of the junction box, and ii) a stud mounting flange of the mounting bracket extends laterally from the side wall of the junction box, wherein the stud mounting flange is connected to a side end margin of the face plate and is configured for attaching the mounting bracket to a wall stud.

16. The method of claim 15, wherein said engaging the side wall of the junction box with the box mounting flange comprises engaging inner and outer side surfaces of the side wall of the junction box with the box mounting flange to retain the junction box on the mounting bracket.

17. The method of claim 15, further comprising inserting junction box between upper and lower alignment flanges attached to the face plate of the mounting bracket to align the mounting bracket on the junction box.

18. The method of claim 15, wherein engaging the side wall of the junction box comprises inserting the box mounting flange between mounting tabs of the junction box.

19. The method of claim 15, wherein the box mounting flange comprises a clip, and wherein said engaging the side wall of the junction box with the box mounting flange comprises clipping the clip on the side wall of the junction box.

20. The method of claim 15, wherein the mounting bracket is a first mounting bracket, the method further comprising engaging a second side wall of the junction box with a box mounting flange of a second mounting bracket such that i) a front surface of a face plate of the second mounting bracket is flush with the front surface of the junction box, and ii) a stud mounting flange of the second mounting bracket extends laterally from the second side wall of the junction box, wherein the stud mounting flange of the second mounting bracket is connected to a side end margin of the face plate of the second mounting bracket and is configured for attaching the second mounting bracket to a second wall stud.
